(19) United States
(12) Patent Application Publication
(10) Pub. No.: US 2007/0087279 A1
(43) Pub. Date: Apr. 19, 2007

(54) Transfer apparatus and transfer method

(75) Inventor: Masahisa Otsuka, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: LINTEC CORPORATION, Tokyo (JP)

(21) Appl. No.: 11/543,926

(22) Filed: Oct. 6, 2006

(30) Foreign Application Priority Data
Oct. 13, 2005 (JP) 2005-298953

(51) Int. Cl. G03G 9/00

(52) U.S. Cl. 430/109.4; 430/110.1

(57) ABSTRACT

There is provided a transfer apparatus 10 which transfers many chips C on a dicing tape DT stretched in a first ring frame 20 to a transfer sheet S stuck in a second ring frame 24. This transfer apparatus 10 is provided with a pressing member 15 which presses the transfer sheet S, and a moving device 16 which supports this pressing member 15. The pressing member 15 is subjected to movement control by the moving device 16 in such a manner that the pressing member 15 presses the transfer sheet S while moving in a circular pattern in a plane.

### BACKGROUND OF THE INVENTION

1. Field of the Invention

The present invention relates to a transfer apparatus and transfer method, and more particularly to a transfer apparatus and a transfer method which transfers a diced semiconductor chip supported in a ring frame through a dicing tape to a transfer sheet.

2. Description of the Related Art

Conventionally, a semiconductor wafer (which will be simply referred to as a “wafer” hereinafter) is diced by a dicing cutter, and thus obtained many diced chips are mounted in a lead frame or a package to be electrically connected for utilization. Although when these chips are picked up from a dicing tape by a collet, the dicing tape serving as a support surface for each chip may be expanded to form a gap between chip end edges in some cases (see, e.g., Patent Reference 1).

[Patent Reference 1] Japanese Patent Application Laid-open No. 2003-257898

However, in case of using an apparatus disclosed in Patent Reference 1 to perform application, since a wide sticking roller is used, a transfer sheet also adheres to a supporter for mounting a wafer, and a chip may be broken when peeling off the sheet. Further, in case of sticking the transfer sheet to a diced chip, a pressing force is given while rotating and moving the sticking roller, thereby resulting in an inconvenience that the chip is pushed down when the chip is vertically long, for example.

### SUMMARY OF THE INVENTION

In view of the above-described inconvenience, it is an object of the present invention to provide a transfer apparatus and a transfer method capable of accurately transferring a transfer target object such as a semiconductor chip.

To achieve this object, according to the present invention, there is provided a transfer apparatus in which a transfer sheet is arranged on an upper surface side of a transfer target object supported by a supporter to transfer the transfer target object to the transfer sheet, the transfer apparatus comprising a pressing member which presses the transfer sheet to be transferred to the transfer target object, wherein the pressing member is provided with a pressing surface smaller than an area of the transfer target object and supported by moving means for pressing the transfer sheet to transfer the transfer target object to the transfer sheet while moving in a circular pattern in a plane.

Further, according to the present invention, there is provided a transfer apparatus in which a transfer sheet is arranged on an upper surface side of a transfer target object supported by a supporter to transfer the transfer target object to the transfer sheet, the transfer apparatus comprising a pressing member which presses the transfer sheet to be transferred to the transfer target object, wherein the pressing member is provided with a pressing surface smaller than an area of the transfer target object and supported by moving means for intermittently pressing the transfer sheet to transfer the transfer target object to the transfer sheet by moving in a predetermined direction with up-and-down and back-and-forth movements.

In the present invention, the transfer target object comprises many diced electronic components supported by a dicing tape, and an area of the transfer target object is a total area of an aggregation of the electronic components, and the transfer apparatus includes an expanding device which expands the dicing tape to form a gap between end edges of these electronic components.

Furthermore, according to the present invention, there is provided a transfer method which arranges a transfer sheet on an upper surface side of a transfer target object supported by a supporter to transfer the transfer target object to the transfer sheet, the transfer method comprising: arranging the transfer sheet on the upper surface side of the transfer target object; placing a pressing member provided with a pressing surface smaller than an area of the transfer target object above the transfer sheet; and pressing the transfer sheet to transfer the transfer target object to the transfer sheet while moving the pressing member in a circular pattern in a plane.

Moreover, according to the present invention, there is provided a transfer method which arranges a transfer sheet on an upper surface side of a transfer target object supported by a supporter to transfer the transfer target object to the transfer sheet, the transfer method comprising: arranging the transfer sheet on the upper surface side of the transfer target object; placing a pressing member provided with a pressing surface smaller than an area of the transfer target object above the transfer sheet; and intermittently pressing the transfer sheet to transfer the transfer target object to the transfer sheet while involving up-and-down and back-and-forth motions of the pressing member and a movement of the same in a predetermined direction in a plane.

According to the transfer apparatus and the transfer method of the present invention, since the pressing member presses the transfer sheet with a movement in a circular pattern in a plane or up-and-down and back-and-forth motions, a pressing force is exercised with respect to a necessary part alone, thereby assuredly preventing the transfer sheet from sticking to parts other than the transfer target object.

In particular, according to the present invention, even if a gap is formed between end edges of electronic components constituting the transfer target object through the expanding device, the electronic components can be prevented from being pushed down by provision of the pressing force.

### BRIEF DESCRIPTION OF THE DRAWINGS

FIG. 1 is a schematic front view of a transfer apparatus according to an embodiment; FIG. 2 is an upper side view of FIG. 1; FIG. 3 is a plan view of a table used for transfer; FIG. 4 is a front view showing an initial state where a first supporter is supported between first frame holders; FIG. 5 is a front view showing a state where a dicing tape is expanded to form a gap between chips; FIG. 6 is a front view showing a state where a second supporter is supported between second frame holders; FIG. 7 is a front view showing a state where chips are transferred to a transfer sheet constituting a second supporter; FIG. 8 is a plan view showing an example of a movement trajectory when a pressing member presses the transfer sheet; and FIG. 9 is a plan view showing a movement trajectory when the pressing member presses the transfer sheet with up-and-down and back-and-forth motions.

### DETAILED DESCRIPTION OF THE PREFERRED EMBODIMENT

An embodiment according to the present invention will now be described hereinafter with reference to the accompanying drawings.

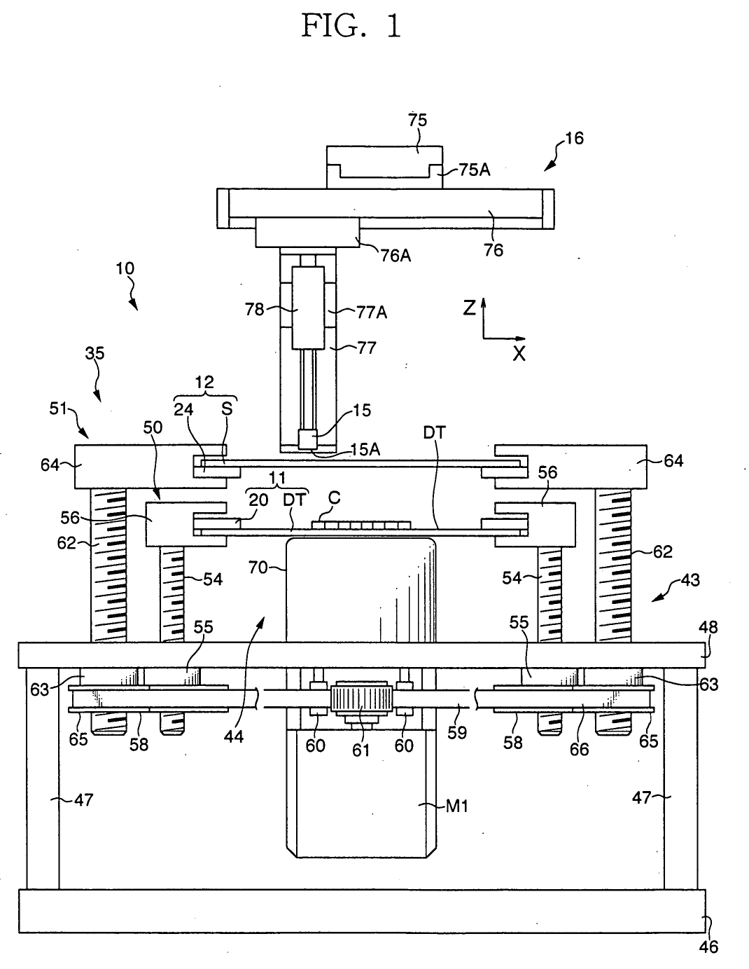

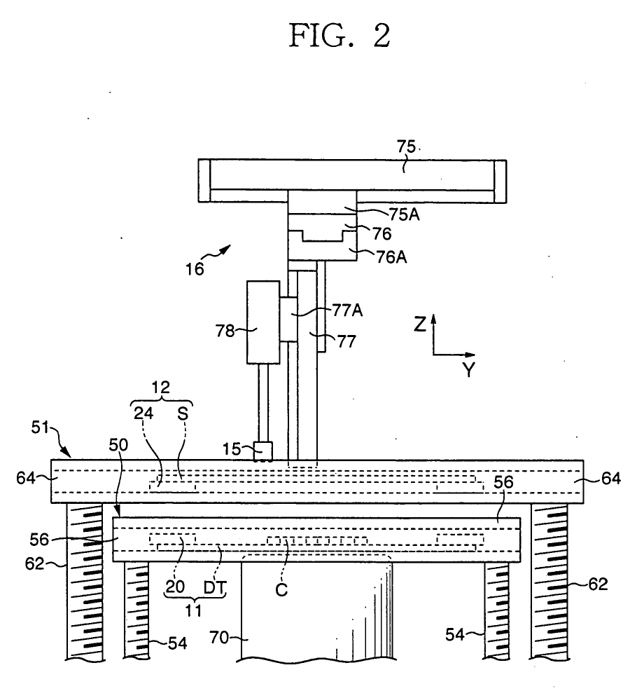

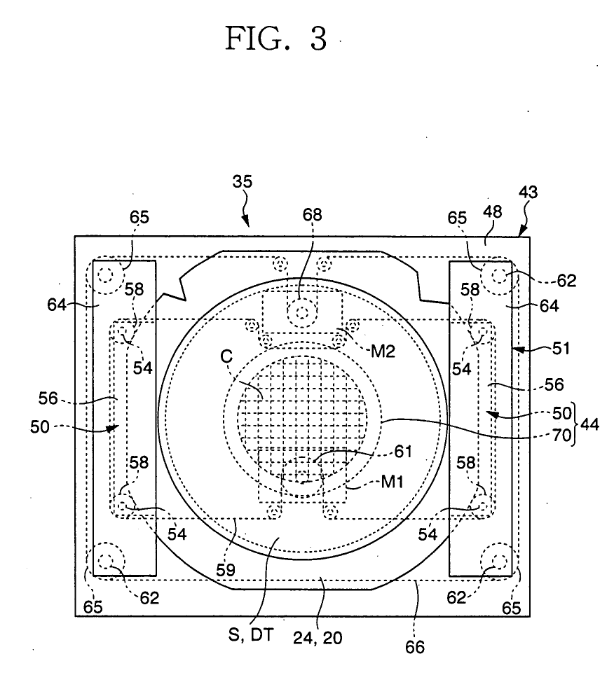

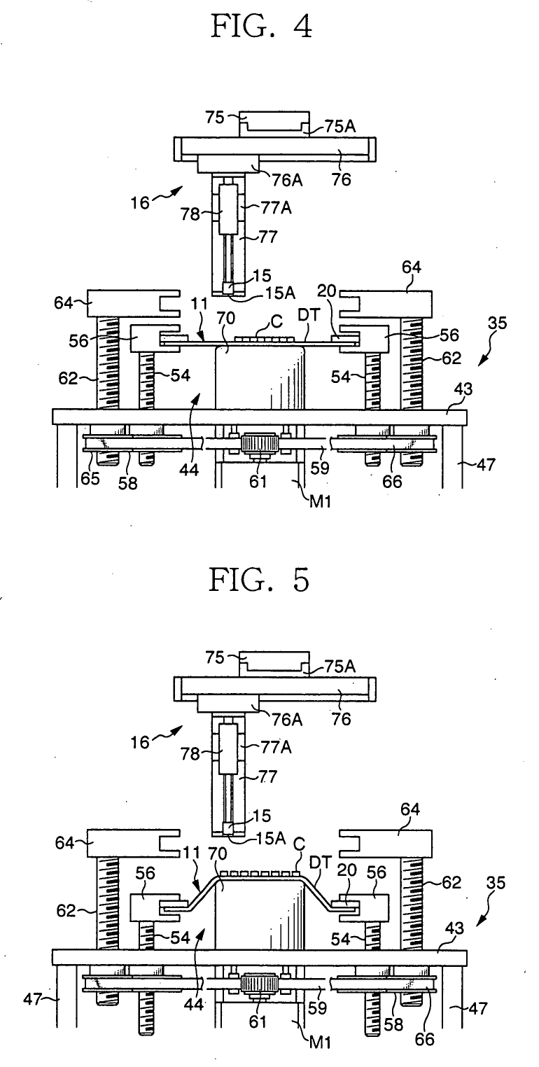

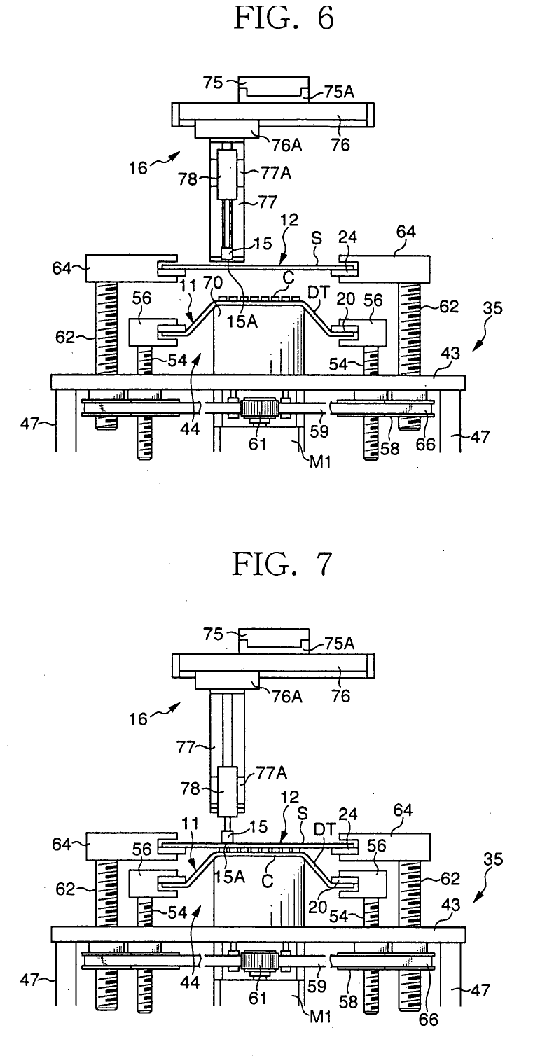

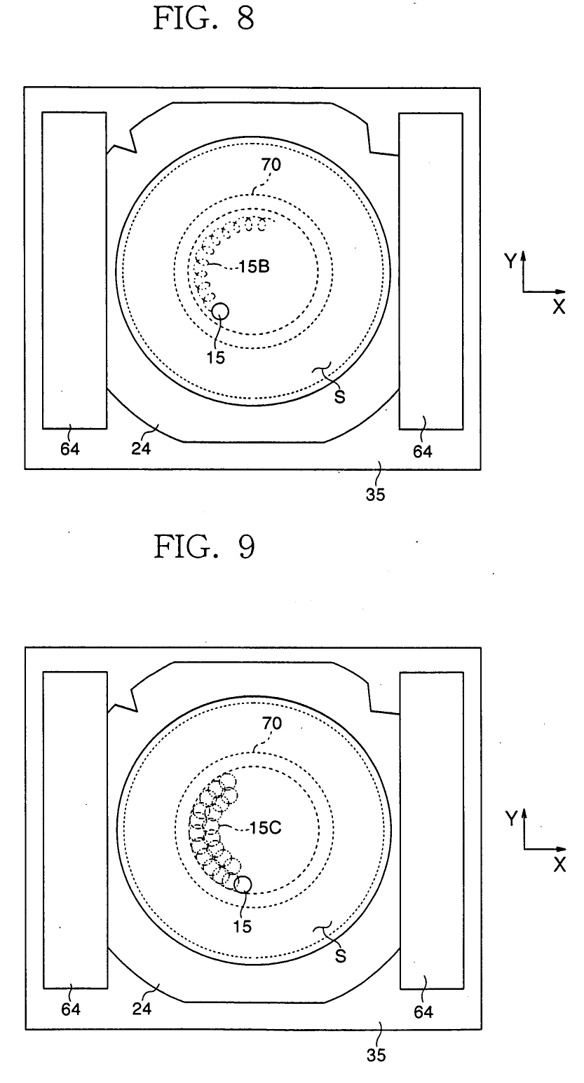

FIG. 1 is a schematic front view of a transfer apparatus according to this embodiment, and FIG. 2 is an upper side view of FIG. 1. In these drawings, a transfer apparatus 10 comprises a table 35 supporting a first supporter 11 and a second supporter 12, a pressing member 15 positioned above the second supporter 12, and a moving device 16 which movably supports this pressing member 15. The first supporter 11 is formed of a first ring frame 20 and a dicing tape DT stuck in an inner circumferential region of this first ring frame 20, and many chips C as electronic components as a transfer target object are supported on an upper surface side of the dicing tape DT in a state where end edges of these chips are substantially in contact with each other. These chips C are obtained by dicing one wafer into cubic pieces in preceding process. It is to be noted that the dicing tape DT includes an ultraviolet curing adhesive layer on an upper surface side in FIG. 1, and the chips C are stuck on this adhesive layer.

The second supporter 12 is made up of a second ring frame 24 and a transfer sheet S stuck in an inner circumferential region of this second ring frame 24. The transfer sheet S includes an ultraviolet curing adhesive layer on a lower surface side in the drawing to which the chips C are transferred.

The table 35 includes a table main body 43 and an expanding device 44 provided to the table main body 43. The table main body 43 is formed of a base plate 46 and an upper plate 48 supported by the base plate 46 in parallel through a support rod 47. A first holding device 50 and a second holding device 51 which respectively support the first and second supporters 11 and 12 to allow up and down movements are provided in a surface of the upper plate 48.

As shown in FIG. 1, the first holding device 50 is comprises four screw shafts 54 which pierce the upper plate 48 to extend in a vertical direction, a bearing portion 55 which allows each pulley 58 to be rotatably fixed on a lower surface of the upper plate 48 and supports each screw shaft 54 by rotation of the pulley 58 to move up and down, and a pair of right and left first frame holders 56, the two screw shafts 54 being fixed to each of the first frame holders 56. Additionally, each pulley 58 is connected to a driving pulley 61 fixed to an output shaft of a motor M1 by an endless belt 59 (see FIG. 3). As a result, the first supporter 11 supported by the first frame holders 56 can move up and down by rotation of the motor M1. It is to be noted that the motor M1 is suspended on a lower surface side of the upper plate 48.

The second holding device 51 has substantially the same arrangement as that of the first holding device 50. That is, as shown in FIG. 1, the second holding device 51 comprises four outer screw shafts 62 which pierce the upper plate 48 to extend in the vertical direction, a bearing portion 63 which allows each pulley 65 to be rotatably fixed on the lower surface of the upper plate 48 and supports each outer screw shaft 62 by rotation of the pulley 65 to move up and down, and a pair of right and left second frame holders 64, the two outer screw shafts 62 being fixed to each of the second frame holders 64. Additionally, each pulley 65 is connected to a driving pulley 68 fixed to an output shaft of a motor M2 by an endless belt 66 (see FIG. 3). As a result, the second supporter 12 supported by the second frame holders 64 can move up and down by rotation of the motor M2. It is to be noted that the motor M2 is also suspended on the lower surface side of the upper plate 48 like the motor M1.

A circular pedestal 70 having a plane area larger than that of all the chips C on an upper surface thereof is arranged at a central part of the upper plate 48, the dicing tape DT is expanded in a radial direction when the frame holders 56 move down, and end edges of the respective chips C sticking to the dicing tape DT are separated from each other. Here, the first holding device 50 and the pedestal 70 constitute the expanding device 44.

The moving device 16 which movably supports the pressing member 15 comprises a Y-axis robot 75, an X-axis robot 76 attached to a slider 75A of the Y-axis robot 75, and a Z-axis robot 77 attached to a slider 76A of the X-axis robot 76. The Z-axis robot 77 includes a slider 77A which is movable along a Z axis direction, and the pressing member 15 is supported at a rod end of a cylinder 78 which attached to the slider 77A. Here, the pressing member 15 has a pressing surface 15A at a lower end surface being smaller than an area of the transfer target object (an aggregation of the chips C). Note that, the cylinder 78 is connected with a non-illustrated air regulator so that a pressing force of the pressing member 15 is maintained constantly.

An transferring operation in this embodiment will now be described with reference to FIGS. 4 to 9. Here, it is assumed that each chip C stuck on the dicing tape DT is irradiated with ultraviolet rays from the dicing tape DT side in advance so that its adhesive force is lowered.

After the first supporter 11 which supports the chips C on the table 35 is transferred to a space between the pair of right and left first frame holders 56 through a non-illustrated robot as shown in FIG. 4, the belt 59 is rotated by rotation of the motor M1 to move down the first frame holders 56 as shown in FIG. 5. This downward movement expands the dicing tape DT, and a gap is formed between end edges of the respective chips C supported on the dicing tape DT. This gap is detected by a non-illustrated gap detection device such as a camera. When a predetermined gap dimension between chip end edges is reached, a signal is output to a non-illustrated control device to stop downward movement of the first frame holders 56.

Then, as shown in FIG. 6, the second supporter 12 is transferred to a space between the second frame holders 64 through a non-illustrated transfer robot.

In a state where the first and second supporters 11 and 12 are placed at upper and lower positions in this manner, the belt 66 rotates by rotation of the motor M2 to move down the second frame holders 64, thereby bringing an adhesive surface (the lower surface) of the transfer sheet S into contact with the upper surfaces of the chips C. Further, as shown in FIG. 7, the pressing member 15 moves down to press the transfer sheet S from the upper side through the Z-axis robot 77 of the moving device 16. Furthermore, as shown in FIG. 8, the pressing member 15 moves in X and Y directions little by little in a plane in such a smaller circular pattern as indicated by a movement trajectory 15B by a relative motion of the Y-axis robot 75 and the X-axis robot 76, and presses and transfers the adhesive surface of the transfer sheet S to the upper surfaces of the chips C. Moreover, as shown in FIG. 9, the pressing member 15 can move in a predetermined direction little by little as indicated by a trajectory 15C with up-and-down and back-and-forth motions by the Z-axis robot 77 to intermittently press the transfer sheet S, thereby the chips C can be transferred to the transfer sheet S.

After transferring the chips C to the transfer sheet S, the first and second supporters 11 and 12 are transferred to a non-illustrated table in a state where their relative posture is maintained, and they are turned upside down so that the first supporter 11 is maintained at a position above the second supporter 12. Additionally, in this state, the first ring frame 20 constituting the first supporter 11 and an adhesive region of the dicing tape DT are irradiated with ultraviolet rays to reduce the adhesive force in these parts.

Subsequently, the dicing tape DT is removed from the first ring frame 20 and the chips C through a non-illustrated sheet removal device, and the first ring frame 20 is collected, whilst the chips C with the second supporter 12 are stored into a non-illustrated stocker.

Therefore, according to the embodiment, a pressing force is not given by rotating a roller or the like on the transfer sheet, but the pressing member 15 having the small pressing surface 15A moves little by little in the predetermined direction in a plane, and hence the transfer sheet S can be effectively prevented from sticking to the dicing tape DT. Further, when the pressing force is given while involving the up-and-down and back-and-forth motions, it is possible to effectively avoid push-down of the chips C which can occur when forming each gap between the chips C to perform transfer in addition to the above-described effect.

As described above, the best configuration, method and others embodying the present invention are disclosed above, but the present invention is not restricted thereto.

That is, although the present invention is illustrated and described in relation to a specific embodiment in particular, persons skilled in the art can transfer various modifications with respect to a shape, a position, an arrangement and others of the foregoing embodiment without departing from the technical concept and a scope of the objects of the present invention.

For example, an area of the pressing surface 15A of the pressing member 15 is not restricted to a specific Value, and it can be increased or reduced as required and changed in accordance with a plane area or the like of each transfer target object. Furthermore, the movement trajectory of the pressing member 15 in a plane can be determined in accordance with a plane shape of the transfer target object.

Moreover, the expanding device 44 is configured to expand the dicing tape DT when the first frame holders 56 move down, but it may expand the same when the pedestal 70 moves up. Namely, in the present invention, expanding to maintain a gap dimension between the end edges of the chips C at a set value can suffice, and means or a configuration for this expanding operation is not restricted in particular.

Additionally, the transfer target object is not restricted to the chip, and it includes other electronic components such as a light emitting diode.

What is claimed is:

1. A transfer apparatus in which a transfer sheet is arranged on an upper surface side of a transfer target object supported by a supporter to transfer the transfer target object to the transfer sheet,
the transfer apparatus comprising a pressing member which presses the transfer sheet to be transferred to the transfer target object, wherein the pressing member is provided with a pressing surface smaller than an area of the transfer target object and supported by moving means for pressing the transfer sheet to transfer the transfer target object to the transfer sheet while moving in a circular pattern in a plane.

2. A transfer apparatus in which a transfer sheet is arranged on an upper surface side of a transfer target object supported by a supporter to transfer the transfer target object to the transfer sheet,
the transfer apparatus comprising a pressing member which presses the transfer sheet to be transferred to the transfer target object, wherein the pressing member is provided with a pressing surface smaller than an area of the transfer target object and supported by moving means for intermittently pressing the transfer sheet to transfer the transfer target object to the transfer sheet by moving in a predetermined direction with up-and-down and back-and-forth movements.

3. The transfer apparatus according to claim 1 or 2, wherein the transfer target object comprises many diced electronic components supported by a dicing tape, and an area of the transfer target object is a total area of an aggregation of the electronic components,
and the transfer apparatus includes an expanding device which expands the dicing tape to form a gap between end edges of these electronic components.

4. A transfer method which arranges a transfer sheet on an upper surface side of a transfer target object supported by a supporter to transfer the transfer target object to the transfer sheet,
the transfer method comprising:
arranging the transfer sheet on the upper surface side of the transfer target object;
placing a pressing member provided with a pressing surface smaller than an area of the transfer target object above the transfer sheet; and
pressing the transfer sheet to transfer the transfer target object to the transfer sheet while moving the pressing member in a circular pattern in a plane.

5. A transfer method which arranges a transfer sheet on an upper surface side of a transfer target object supported by a supporter to transfer the transfer target object to the transfer sheet.
the transfer method comprising:
arranging the transfer sheet on the upper surface side of the transfer target object;
placing a pressing member provided with a pressing surface smaller than an area of the transfer target object above the transfer sheet; and
intermittently pressing the transfer sheet to transfer the transfer target object to the transfer sheet while involving up-and-down and back-and-forth motions of the pressing member and a movement of the same in a predetermined direction in a plane.
